(19) United States
(12) Patent Application Publication
(10) Pub. No.: US 2026/0210637 A1
(43) Pub. Date: Jul. 23, 2026

(54) MATERIAL CHILLING/FREEZING SYSTEM

(71) Applicant: Hive Chilling IP Pty Ltd, Howlong, New South Wales (AU)

(72) Inventors: Edward STAUGHTON, Splitters Creek (AU); Simon STAUGHTON, Splitters Creek (AU)

(73) Assignee: Hive Chilling IP Pty Ltd, Howlong, New South Wales (AU)

(21) Appl. No.: 19/142,045

(22) PCT Filed: Dec. 20, 2023
(86) PCT No.: PCT/AU2023/051339

§ 371 Date: Jun. 20, 2025

(30) Foreign Application Priority Data
Dec. 20, 2022 (AU) 2022903914
Oct. 31, 2023 (AU) 2023903481

(51) Int. Cl. F28D 7/10; A22B 7/00; F28D 21/00; F28F 9/02

(52) U.S. Cl. CPC F28D 7/106; A22B 7/008; F28F 9/027; F28D 2021/0042; F28D 2021/0098; F28F 2255/16

(57) ABSTRACT

A heat exchange module for an in-line freezing/chilling system for freezing/chilling materials, comprising: a body forming a conduit having: an internal wall defining an internal space for chilling/freezing materials contained therein, the internal space extending a length of the body; and an external wall spaced from the internal wall to define at least one channel formed therebetween that extends the length of the body; an inlet manifold attached to an inlet end of the body to seal the inlet end, the inlet manifold having at least one inlet for introducing a heat exchange medium into the at least one channel and being controllable to introduce the material to be frozen/chilled into the internal space of the body; and an outlet manifold attached to an outlet end of the body to seal the outlet end, the outlet manifold having at least one outlet for removing a heat exchange medium from the at least one channel and being controllable to receive the frozen/chilled material from the internal space of the body

### RELATED APPLICATIONS

The present application claims priority from earlier filed Australian Provisional Patent Application No 2022903914 filed on 20 Dec. 2022 and Australian Provisional Patent Application No 2023903481 filed on 31 Oct. 2023, the entire contents of which are incorporated herein by reference.

### FIELD OF INVENTION

The present invention relates generally to a system and method for processing organic material and in particular, to a system and method for receiving and chilling/freezing organic material for further processing.

### BACKGROUND ART

In food processing facilities, particularly pet food processing facilities, there is a constant need to receive and process raw organic material into a form where it is capable of being stored and further processed. In-line chilling systems have been developed for such purposes, whereby organic material, such as offal and other internal animal organs, are received and chilled for storage or further processing into pet food products.

Plate freezers are one type of in-line chilling system that has been successful in achieving this. Plate freezers generally comprise a plurality of refrigerated plates mounted within a frame to define a space therebetween, into which the organic material is delivered to be frozen. A refrigerant is delivered to the plates such that the plates act as evaporators to absorb heat energy from the organic material thereby rapidly freezing the organic material. Once frozen the refrigerant circuit is able to be reversed to provide warm gas to the plates to defrost the contact zone between the frozen product and the plate surface to facilitate removal of the frozen product from the plates. In most commercially available plate freezing devices, it is desirable that the organic material to be frozen is able to be quickly loaded into the space formed between the plates and that the resultant frozen material can then be quickly removed as required.

One problem with conventional plate freezers is that the organic material must be supplied into the space between the plates by a filling means, which is typically labour intensive. Further, such plate freezers require removal of the frozen blocks after formation. Removal is typically achieved by manually transferring the frozen blocks onto a pallet or conveyor, which is labour intensive as it can take up to 10 minutes to unload each plate freezer depending upon the number of plates employed. Further, as the blocks are frozen to −15° C. and can weigh up to 70 Kgs, the manually handling of these blocks can present significant safety hazards and requires much skill and effort. Further, through handling the blocks there may be a risk of bacterial contamination of the product. Also, most existing commercial applications employ a conveyor that extends parallel to the plate freezer unit which is an inefficient use of space.

In some food processing facilities, scrape surface heat exchangers are employed to provide a more continuous processing of viscous material, which are capable of continuously cooling (or heating) the moving material. Such devices typically comprise an inner tube having a surrounding jacket through which the heating or cooling medium is circulated through, so as to generate a low or high temperature at the inner surface of the tube. A central shaft is provided within the tube that is driven to rotate, such that scraper blades attached to the shaft rotate across the inner surface of the tube. The material to be processed is delivered into the tube and caused to travel within the tube such that it contacts the inner surface of the tube to facilitate heat transfer between the material and the tube at the inner surface thereof. As the material freezes the scraper blades function to remove the frozen material from the inner surface of the tube, to ensure flow of material therethrough and enhance mixing of the product.

Such scrape surface heat exchangers can readily process liquids and viscous fluids that do not contain fibrous matter. In situations where the material contains fibrous matter, such as offal and animal viscera, the central shaft and rotating scraper blades often clog or become entangled with the fibrous matter, preventing the exchanger from functioning correctly.

In some applications, in-line heat exchange systems have also been proposed similar to scrape surface heat exchanges but without the internal scraper blades. Such systems also function by the material to be processed being delivered into the tube and caused to travel within the tube such that it contacts the inner surface of the tube to facilitate heat transfer between the material and the tube at the inner surface thereof. As the material is constantly moving through the tube it continuously flows from one end of the tube to the other. However, should the material freeze and become a more solid mass due to the contact with the inner surface of the tube, the material may become “stuck” within the tube and flow of material may stop, requiring the system to be overhauled and the refrigerant removed from the system and flushed with a heated fluid to melt the frozen material and remove the material from the tube. Such a process may result in significant downtime for the system and can be costly and time consuming.

Thus, there is a need to provide an alternative heat exchange system that can simply and effectively handle fibrous matter and which can which addresses at least some of the disadvantages of existing systems.

The above references to and descriptions of prior proposals or products are not intended to be, and are not to be construed as, statements or admissions of common general knowledge in the art. In particular, the above prior art discussion does not relate to what is commonly or well known by the person skilled in the art, but assists in the understanding of the inventive step of the present invention of which the identification of pertinent prior art proposals is but one part.

### SUMMARY OF THE INVENTION

Accordingly, in one aspect of the invention there is provided a heat exchange module for an in-line freezing/chilling system for freezing/chilling materials, comprising:
a body forming a conduit having:
   an internal wall defining an internal space for chilling/freezing materials contained therein, the internal space extending a length of the body; and
   an external wall spaced from the internal wall to define at least one channel formed therebetween that extends the length of the body;
an inlet manifold attached to an inlet end of the body to seal the inlet end, the inlet manifold having at least one inlet for introducing a heat exchange medium into the at least one channel and being controllable to introduce the material to be frozen/chilled into the internal space of the body; and
an outlet manifold attached to an outlet end of the body to seal the outlet end, the outlet manifold having at least one outlet for removing a heat exchange medium from the at least one channel and being controllable to receive the frozen/chilled material from the internal space of the body.

In one embodiment, the body may be extruded from a metal and may comprise a plurality of channels extending the length of the body.

In another embodiment, the body may comprise an internal tube that defines the internal space for chilling/freezing materials and an external shell formed over said internal tube to form the at least one channel therebetween.

The inlet manifold may include one or more valve members to control the introduction of the material to be chilled/frozen into the internal space thereof.

The outlet manifold may include cutters, guillotines, and/or robotic handling systems to receive and process the chilled/frozen material into predetermined sizes.

In one embodiment. the cross-sectional shape of the body may be substantially circular. In another embodiment, the cross-sectional shape of the body can be any shape.

Accordingly, in another aspect of the invention there is provided a system for chilling/freezing organic materials, comprising:
an inlet for receiving the organic materials;
a pump for applying a positive pressure to the organic materials to facilitate flow of the organic materials;
at least one module in fluid communication with the pump to receive the organic materials and to store the materials therein for a predetermined period of time, the at least one module having an internal wall in communication with the materials stored therein that is adapted to apply a low temperature to the materials to at least partially freeze the materials and which is adapted to apply a heat to the materials to defrost the materials at an interface between the materials and the internal wall; and
an outlet for receiving the at least partially frozen materials from the at least one module;
wherein, the at least partially frozen materials are received by the outlet from the at least one module under action of the pump following defrosting of the materials.

The at least one module may comprises a tube having an outer shell formed thereabout to define a space between the tube and the outer shell to receive a heat exchange medium.

The tube may receive the organic materials from the pump.

The system may comprises multiple modules arranged in parallel and the modules may be controlled to operate at different cycles.

Accordingly, in yet another aspect of the invention there is provided a method for freezing/chilling materials, comprising:
collecting the materials to be frozen/chilled;
delivering the materials to a module whereby the materials are caused to flow into the module to substantially fill the module;
introducing a refrigerant heat exchange medium into the module to cause the materials present therein to at least partially freeze;
after a predetermined time, introducing a defrost heat exchange medium into the module to replace the refrigerant heat exchange medium to cause the material at the interface of the module to at least partially melt;
delivering fresh material into the module to cause the material present in the module to flow out of the module to be replaced by the fresh material; and collecting the material flowing out of the module for further processing.

The materials may be collected in a collection hopper for processing.

The materials may be delivered to the module under pressure so as to flow into the module to substantially fill the module. The materials may be delivered to the module under pressure supplied by a pump.

The module may comprise an elongated space into which the materials may be delivered and the materials may flow into the elongated space to substantially fill the elongated space.

The module may comprises one or more channels configured to extend along the elongated space such that the refrigerant heat exchange medium is introduced into the one or more channels to cause the material present in the elongate channel to at least partially freeze.

After the predetermined time period, the refrigerant heat exchange medium in the one or more channels may be replaced with the defrost heat exchange medium such that the material present at the interface of the elongate space may be caused to at least partially melt.

The fresh material may be delivered into the module under pressure to cause the material present in the module to flow out of the module. The pressure may be supplied to the fresh material by a pump.

The material flowing from the module may exit the module by way of an exit manifold. The exit manifold may comprise cutters, guillotines, and robotic handling systems to receive and process the material into predetermined sized slabs for further processing.

### BRIEF DESCRIPTION OF THE DRAWINGS

The invention may be better understood from the following non-limiting description of preferred embodiments, in which:

FIG. 1 is a side view of a processing apparatus in accordance with an embodiment of the present invention;

FIG. 2 is a cross sectional view of the apparatus taken along axis A-A of FIG. 1;

FIG. 3 is a top cross sectional view of the apparatus of FIG. 1;

FIG. 4 is a side view of a apparatus in accordance with another embodiment of the present invention;

FIG. 5 is a cross sectional view of the apparatus of FIG. 4 taken along axis B-B;

FIG. 6 is a side view of a apparatus in accordance with yet another embodiment of the present invention;

FIG. 7 is a side view of a processing apparatus in accordance with another embodiment of the present invention;

FIG. 8 is a perspective view of a heat exchange module of the apparatus of FIG. 7;

FIG. 9 is a cross-sectional end view of the heat exchange module along line A-A of FIG. 7;

FIG. 10 is a cross-sectional end view of the heat exchange module along line B-B of FIG. 7; and

FIG. 11 is a cross sectional end view of the body of the heat exchange module of FIG. 8.

### DETAILED DESCRIPTION OF AN EMBODIMENT OF THE INVENTION

The present invention will be described below in relation to its application for use in creating frozen logs of animal protein matter, such as animal viscera and offal, for use in pet food production. However, it will be appreciated that the present invention could be equally employed in processing a variety of other matter, such as fish for pet food, fruit and vegetable pulp, water (block ice), beef trimmings, chicken, mechanically deboned meat (MDM), dairy products as well as waste organic products that require chilling prior to disposal or further processing. Further, the apparatus of the present invention could be used to form frozen or partially frozen logs of material as may be required.

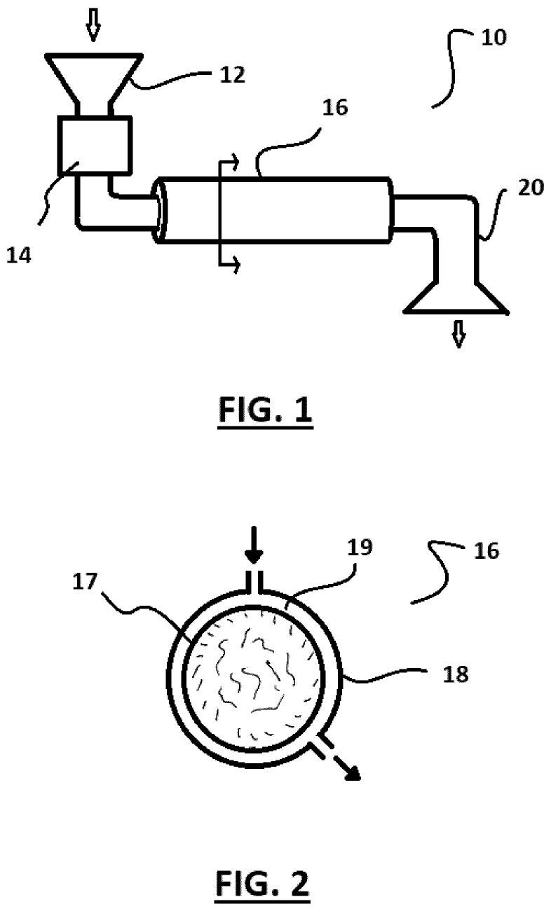

Referring to FIG. 1, a processing apparatus 10 is depicted in accordance with an embodiment of the present invention. The apparatus 10 comprises an inlet 12 for receiving the material to be processed and a pump 14 for pressurising the material to pass through the apparatus 10. The pump 14 may be a mechanical positive displacement pump or a pneumatic pump and will be operated in a manner to be described in more detail below.

A heat exchange module 16 is in fluid communication with the inlet 12 to receive the material to be processed, which is delivered under pressure from the pump 14. The module 16 is shown in cross-section in FIG. 2 and is in the form of a tube 17 having an outer shell 18 extending thereabout to define a space 19 into which the heat exchange medium is to be provided.

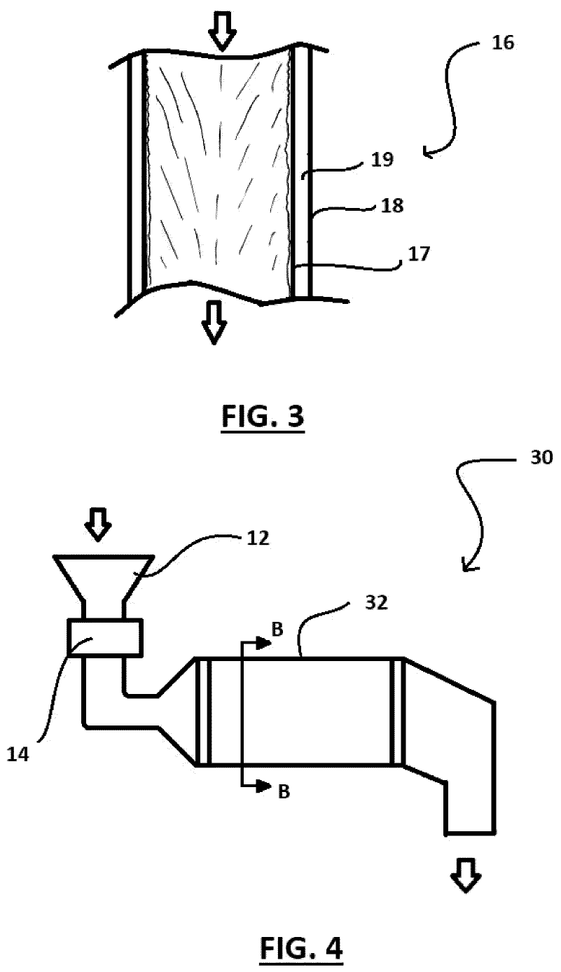

The heat exchange medium will initially be a refrigerant that passes into the space 19 to chill and partially freeze the material within the tube 17. As the material within the tube will freeze from the walls of the tube 17 (the contact zone) and then progressively inwardly to the core of the tube 17, the temperature of the material may be monitored to ensure that the material achieves a desired temperature. This may be achieved by a variety of ways, including the use of sensors as well as managing the time the material is present within the tube 17. Upon the material reaching a desired temperature or being present within the tube for a predetermined time period, the refrigerant will be removed from the space 19 and replaced with a hot fluid, such as a hot gas or liquid, which will then cause the material at the contact zone to defrost and release from the internal surface of the tube 17, as is shown in FIG. 3.

The pump 14 will then be actuated to push new material into the module 16 to replace the processed material present therein, the processed material will then exit the module 16 to be removed by the exit manifold 20. The release of the processed material may also be assisted by expansion of tube 17 resulting from the replacement of the refrigerant with the hot fluid, which will result in a temperature change at the contact zone in the region of (−30° C.) to (+8° C.). The exit end of the tube 17 leading into the exit manifold 20 may also taper outwardly to assist in flow of the processed material from the tube and into the exit manifold.

Such a system for processing material functions by freezing a percentage of a given amount of organic material and then mixing the unfrozen portion with the frozen portion as the material exits the module 16 to create a finished chilled product. The finished chilled product temperature may be determined by the amount of frozen material in the mixture compared to the percentage of unfrozen material. The freezing efficiency of the module 16 may be determined by size of the tube (larger less efficient) and the time in which the material is present within the tube, i.e. refrigeration time.

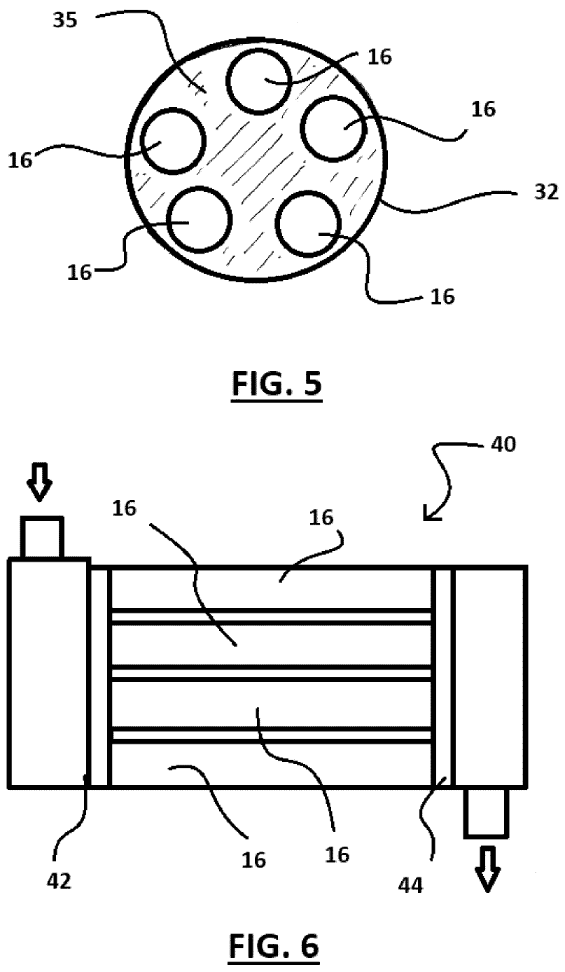

It will be appreciated that the system of the present invention is intended for batch processing raw material with the process having a freezing step and a defrosting step to facilitate removal of the frozen/chilled material in batches for further processing. To form a continuous in-line chilling system for mass processing of material, multiple modules 16 may be configured in parallel with the modules operating at different cycle phases to ensure that batches of material are being continuously fed from the modules for processing. One embodiment of such an arrangement is depicted in FIG. 4 and FIG. 5.

In this embodiment, the system 30 comprises a drum 32 that houses multiple modules 16, each of which are linked in parallel to the inlet 12 and supply pump 14 via a distribution manifold 34 which has automatically actuated supply valves (not shown) to fill each module individually.

As is shown in FIG. 5, in this embodiment each of the modules 16 are configured to extend in a parallel manner within the drum 32 and are isolated from each other by way of insulation material 35 that fills the space therebetween. The modules 16 are individually plumbed to allow for a maximum supply of refrigerant for minimum freezing time and hot gas supply for quick defrost.

It will be appreciated that by controlling the pump 14 and the supply valves to each module, the modules 16 can be automatically controlled to keep pace with incoming raw material requirements. In this regard, the modules 16 can be controlled by a simple microcontroller to be at differing stages or phases of the process so that the system 30 can operate as a continuous processing system by individually sequentially filling, freeze/chilling, mixing hot & cold portions and then taking away chilled end product for storage.

An alternative embodiment of a system 40 having multiple modules 16 is depicted in FIG. 6. In this system 30, each of the modules 16 are arranged in a vertical stack between an inlet manifold 42 and an outlet manifold 44, with each module 16 being separated to function independently of the other modules 16. It will be appreciated that the modules 16 may alternatively be arranged in a horizontal arrangement and various other configurations, as dictated by the available space for receiving the system.

Each module 16 may have a different configuration depending upon the material to be processed. In this regard, the diameter of the tubes 17 of the modules 16 can be varied to suit the material being processed, and the size of the particles in the material mix. By way of example, lung lobes could be processed in tubes 17 having a 150 mm diameter, and 100 mm diameter tubes 17 could be used for kidney plate, ground whole sheep and pig offal. Other tube sizes and configurations could be used to process other materials, as will be dictated by the application.

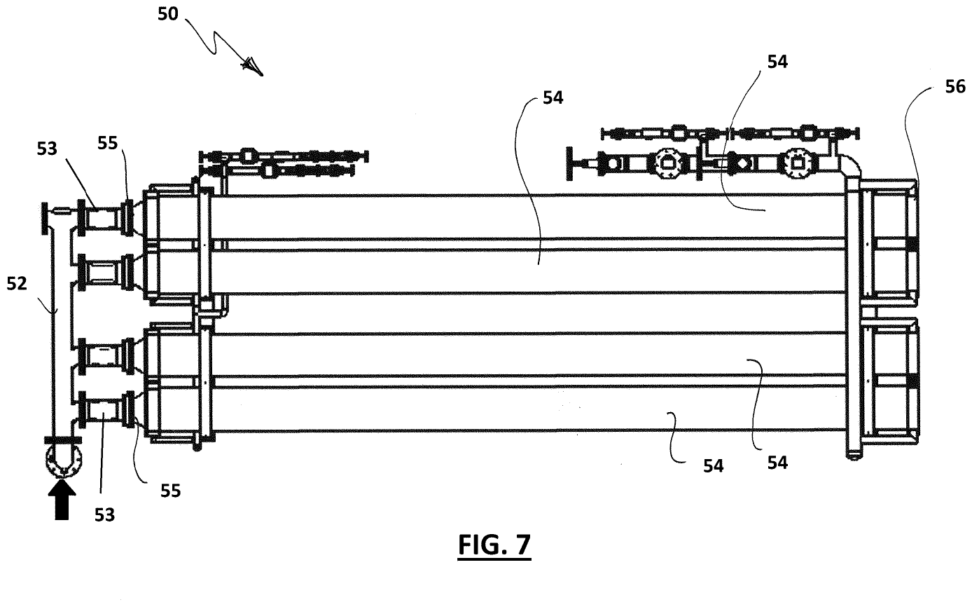

Referring to FIG. 7, an alternative embodiment of a processing apparatus 50 is depicted in accordance with another embodiment of the present invention. The apparatus 50 will be described below in relation to an apparatus for freezing material; however, it will be appreciated that the apparatus may be employed for partial freezing or chilling material, as may be required.

The apparatus 50 comprises an inlet 52 for receiving the material to be processed which is supplied under pressure by a pump (not shown). The apparatus 50 also comprises a collection region 56 for receiving the processed material.

A plurality of heat exchange modules 54 are arranged in fluid communication with the inlet 52 to receive the material to be processed. The material is delivered under pressure into an inlet manifold 55 of the heat exchange modules 54. In the embodiment as shown, the heat exchange modules may be arranged in an array comprising ten vertically spaced banks of parallel heat exchange modules 54, with each bank having eight horizontally spaced modules 54. However, it will be appreciated that the manner in which the modules 44 are arranged can vary depending on the space requirements, other array configurations are also envisaged.

The inlet manifold 55 of each heat exchange module 54 may be connected to the inlet 52 by way of a pinch valve 53 that is controlled to release material into the heat exchange module 54, as required. To avoid short circuiting of the system, the inlet and/or outlet of all but the module 54 that is being filled is restricted during operation. As will be described in more detail below, upon receipt of the material into the heat exchange modules 54, a heat exchange medium, such as a refrigerant, is supplied to the module 54 and the material is exposed to the freezing temperatures of the heat exchange medium through the walls of the module 54.

In accordance with an embodiment of the present invention, to aid in identifying when the frozen material is to be released from the module 54 to the collection region 56 and replaced with fresh material for freezing, temperature sensors may be provided in the module 54 to determine the temperature of the material. Additionally, in order to determine when the frozen/chilled product has been completely unloaded and the module 14 is full of fresh unchilled/unfrozen material, as the material passes each temperature sensor, a temperature change from frozen (around −14° C.) to fresh (around +25° C.) may be recorded. Typically, the actual temperature of the material does not need to be recorded as the system will only need to determine that there has been a change in temperature of around 2-3° C. as the frozen material is displaced by the fresh material. In other embodiments, the temperature sensors may be replaced by a time measuring system that calculates exposure time of the material within the modules to determine when the material is to be released. A variety of other systems for controlling the release of the product and for determining the state of the material being processed are also envisaged based in an understanding of the material properties of the material being processed and the temperature conditions of the system.

By way of example, in a variation of the above-described embodiment of apparatus 50, two temperature sensors may be provided. A first sensor may be located at the module 54 around 800 mm from the exit to the collection region 56 and a second sensor may be located immediately adjacent the exit of the module 54 to the collection region 56. As the material is supplied to the module 54 under pressure, the fresh material may move within the module 54 at a speed of approx. 600mm/sec. As such, detection of a change in temperature at the first sensor will warn the system to control the pinch valve associated with that module 54 to close the switch valve and activate the switch valve of an adjacent module 54 immediately as the second sensor registers a temperature change. In this regard, when the first sensor registers a temperature change an adjacent module 54 may be immediately opened such that the module can be closed and the adjacent module opened for filling when the second sensor detects a change. This would avoid dead-heading of the inlet 52 against each of the module pinch valves. It will be appreciated that other means for coordinating the delivery of fresh material into the modules are also envisaged.

It will be appreciated that when the fresh material is delivered into the modules 54 and is exposed to the freezing temperatures present therein for a predetermined period of time, the refrigerant will then be replaced with a heat source to facilitate release of the frozen material under pressure. This may be achieved by supplying a warm liquid or gas into the module 54 to perform a defrosting step.

To eject the frozen/semi frozen “logs” of material from each module 54, fresh product is pumped into the module 54 from behind the frozen/semi frozen “log”. This acts to push the frozen/semi frozen product out of the module 54 following the de-frost step. This can significantly reduce the turnaround time until the next freeze cycle as it combines the unload and load function into a single step. It will be appreciated that in an alternative embodiment, a supply of compressed air could also be used to aid in ejecting the frozen/semi frozen “logs” from the module 54. Other means for pressurised ejection of the frozen/semi frozen “logs” from the module 54 are also envisaged.

It will be appreciated that the ejection of the frozen/semi frozen “logs” of material is assisted by the different behaviour of metal and high moisture material products during temperature transitions. In this regard, during the freezing step, the metal modules 54 contract and the product within the modules 54 expands. During the defrost step, the metal modules 54 expand and, on a surface of frozen material inside the modules, the ice reverts to liquid resulting in reduction of product volume and lubrication at the material/module interface. Thus, the frozen/semi frozen “logs” of material are free to be ejected from the modules. To assist in this process, the ends of the modules adjacent the collection region may have interior walls that taper outwardly, to enhance flow of the frozen/semi frozen “logs” from the module 54.

The collection region 56 will receive the frozen material expelled from the modules 16 in elongate lengths of frozen material. The collection region may include cutters, guillotines, and robotic handling systems to receive and process the frozen material into predetermined sized slabs, which can be then delivered to a processing station for further processing or palletizing.

In some embodiments, the individual tubes that form the modules 54 may be insulated and encased with a waterproof sleeve (not shown). The waterproof sleeve may be made from a metal, such as stainless steel, or a plastic material. The provision of such an insulated sleeve provides increased energy efficiency within the system that is not possible with other systems, such as plate freezer systems.

Furthermore, the inline nature of the present system allows for a clean-in-place (CIP) cleaning circuit that requires minimal water usage, when compared with other systems such as plate freezer systems. Additionally, the freeze/de-frost process, ensures that the inside wall of the tube is cleaned every time the cycle is employed, obviating the complicated and labour-intensive cleaning process synonymous with scrape surface heat exchange systems. In addition, the present invention provides an ability to chill/freeze liquid products within the inline tube. This avoids any leakage of fluid that is common with plate freezer systems which require opening and closing of the plates, which can release fluid therefrom.

Whilst the modules 54 may be formed from a stainless steel tube to form frozen round logs of material, such a tubular system does not provide for other shapes of material, such as blocks and the like which may have a square or rectangular profile. The provision of blocks of frozen material having a flat profile allows for palletising of blocks that can be used to substitute current industry standard frozen pallets formed by conventional plate freezing methods, without major disruption to end users' production systems. However, manufacturing a flat profile module 54 from stainless steel is not practically achievable due to pressure vessel requirements of the module.

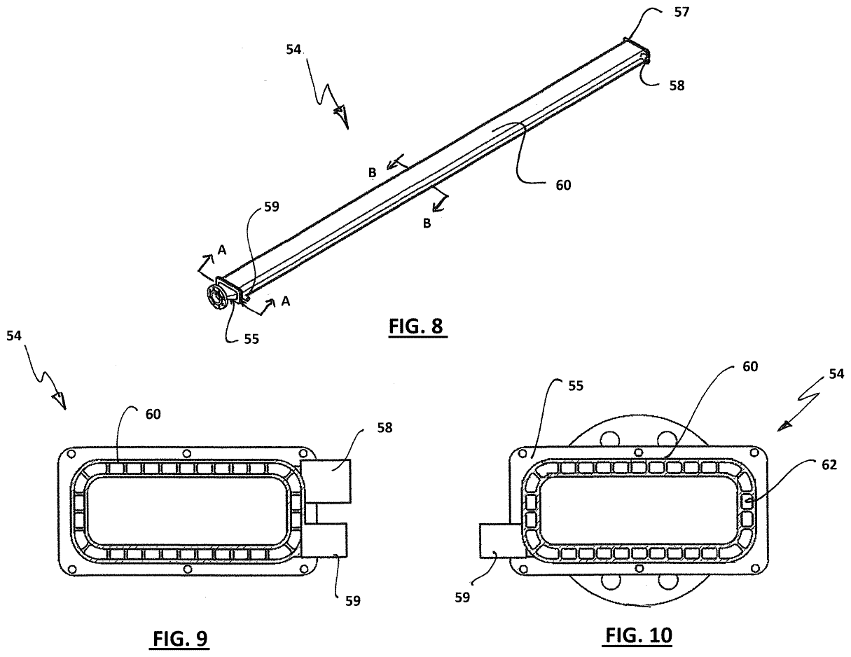

For this reason, a module 54 as depicted in FIGS. 8-11 has been proposed. The module 54 has an elongate body 60 formed from an extruded metal material, such as aluminium, with in-built refrigeration channels 62 formed during the extrusion process, to receive the refrigerant for freezing and the warn liquid/gas for defrosting, while complying with the desired pressure vessel requirements. It will be appreciated that whilst the module 54 has a body 60 of substantially square or rectangular cross section, the body may be formed to take on any variety of cross-sectional shapes, as required.

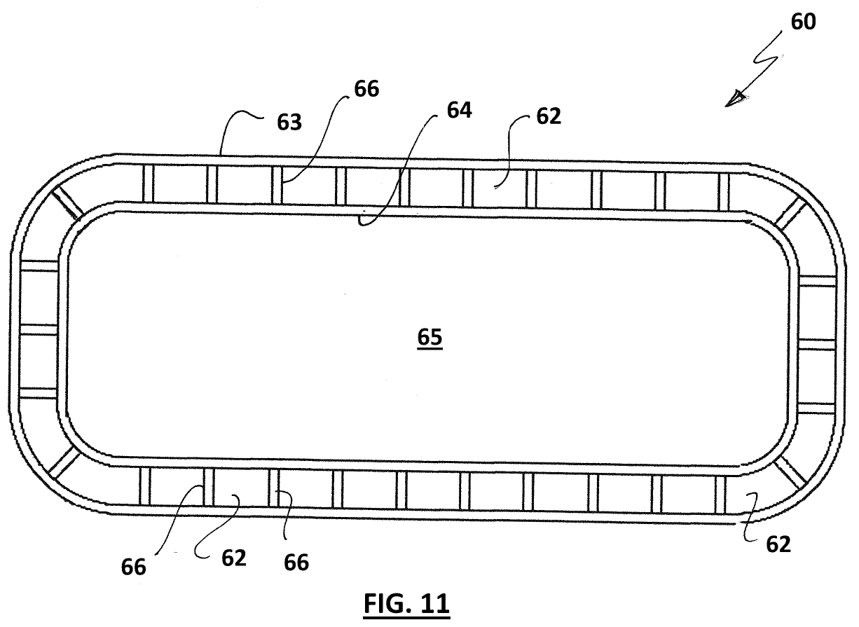

Referring to FIG. 11, a cross-sectional view of the body 60 in accordance with one embodiment of the invention is shown. The body 60 has a continuous internal wall 64 that defines an internal space 65 into which the material is received for freezing. An external wall 63 is spaced from the internal wall 64 and is supported by way of support struts 66 spaced apart to extend between the internal wall 64 and external wall 63. Channels 62 are formed between the support struts 66 and the internal wall 64 and external wall 63 that extend the length of the body 60. The channels are able to receive a refrigerant from a refrigerant supply to facilitate freezing of the material within the internal space 65 and are able to be connected to a heat supply to facilitate defrosting of the frozen material in the space 65 at the interface with the internal wall 64, to facilitate removal of the frozen material from the body in the manner as discussed above.

The dimensions of the body 60 will vary depending on the requirements of the material being processed. In one embodiment, the body 60 may have an external width of between 300-350 mm and a height of between 90-110 mm. The channels 62 may have a height and width of between 10-15 mm. Such dimension are merely examples of one embodiment of the invention and the dimensions can be varied depending on the requirements of the system and the material being processed.

Referring to FIGS. 8-10, the module 54 is shown in isolation. The module 54 generally comprises the body 60 extending between an inlet manifold 55 and an outlet manifold 57. In a preferred embodiment the body 60 may have a length of around 6000 mm, although other lengths are also envisaged, as will be appreciated by those skilled in the art.

The inlet manifold 55 has an inlet port 59 which is connected to both a refrigerant source and a heat source for selectively supplying heat exchange fluid to the channels 62 as required. The outlet manifold 57 has an outlet port 58 for removing the heat exchange fluid as it passes through the channels 62 along the length of the body 60. It will be appreciated that the system may include a microcontroller that controls and coordinates the supply of the heat exchange fluid to each module 54 as required. During use, upon defrosting of the module 54, the outlet port 58 will be used to supply a heating liquid or gas, and the inlet port 59 will be used to remove the heating liquid or gas, so that the flow is counter to the supply of refrigerant liquid.

The body 60 functions as a sealed body having extruded inner and outer walls defining an internal space 65 and longitudinal channels 62 that extend the length of the body. The body 60 is open at opposing ends to facilitate mating with the inlet and outlet manifolds 55, 57 to seal the internal space 65 and channels 62 and allow delivery of the heat exchange medium to the channels 62. As previously discussed, due to the extruded nature of the body 60, the channels 62 are pressure rated refrigeration channels and the body 60 can be made to any cross-sectional shape as desired. Such shapes would include standard geometrical shapes, including round and oval derivatives, squares and rectangles with/without radius corners. Flower shaped cross-sections are also envisaged as are other more irregular shapes.

It will be appreciated that the provision of such an extruded closed tube, of variable shape and size, having suitably located refrigeration channels extending longitudinally therealong of a desired pressure rating, provides for an in-line freezing/chilling system capable of achieving quick and efficient processing of frozen material for food and other related applications.

The system of the present invention is able to handle any pumpable meat or offal products, with the size of the particles only restricted by the limitations of the pump. In most embodiments, a basic pre-grind of material prior to processing will ensure the most efficient results. In this regard, conventional scrape surface heat exchangers cannot process whole meat or organ products because of fouling and hang up on internal scraper mechanisms.

It will be appreciated that the present invention can also be used to process animal product that is typically difficult to process in conventional scrape surface heat exchangers. In this regard, caul fat, which is conventionally difficult to chill due to its change of state from warm (slippery) to chilled (solid and sticky), could be pneumatically pumped in from the kill floor and processed using the present system. The caul fat will easily fill the modules of the present system when warm and after chilling, upon applying the defrost step, the caul fat will readily melt at the tube interface to facilitate easy release of the chilled product under the action of the pump to be removed from the modules.

It will be appreciated that the system of the present invention provides a freezing/chilling system that is easy to clean, as it has no hang-up points as is the case with conventional scrape surface heat exchangers. The system of the present invention is also able to chill products without adding ice, CO2, etc, including offals and fats from sheep, cattle, pig and chicken. Due to the modules of the present system, the system is scalable and is able to be simply adapted to suit the needs of the user by adding/subtracting modules as required. The system can also be configured to have a minimal footprint and can be adapted to suit a particular location, as the modules can be aligned in any direction/angle to suit the available site.

The system of the present invention is also highly amenable for use as a Cleaning in Place (CIP) system, especially when compared to conventional scrape surface heat exchangers that require removal of the scraping elements prior to cleaning. With the present invention, at the completion of each processing cycle, all product is removed from the tubes as the processed product is expelled through the system. CIP techniques can be simply employed in the fill pump, delivery line and takeaway manifold system and downstream of the pump, no part of the system will require opening for access to manual cleaning once the CIP process has been established.

As mentioned previously, whilst the system of the present invention has been described for use in processing offal and related animal products for chilling/freezing, the present system could also be employed for fully freezing suitable specific products where traditional blocks are not necessarily required, such as freezing fish, such as pilchards, on a boat for fish farm feed. In such an example, the pilchards could be pumped into the module, processed and then ejected fully frozen into bulk skips to be held in a freezer storage. Other similar applications of the present system are also envisaged.

Throughout the specification and claims the word “comprise” and its derivatives are intended to have an inclusive rather than exclusive meaning unless the contrary is expressly stated or the context requires otherwise. That is, the word “comprise” and its derivatives will be taken to indicate the inclusion of not only the listed components, steps or features that it directly references, but also other components, steps or features not specifically listed, unless the contrary is expressly stated or the context requires otherwise.

Orientational terms used in the specification and claims such as vertical, horizontal, top, bottom, upper and lower are to be interpreted as relational and are based on the premise that the component, item, article, apparatus, device or instrument will usually be considered in a particular orientation, typically with the apparatus uppermost.

It will be appreciated by those skilled in the art that many modifications and variations may be made to the methods of the invention described herein without departing from the spirit and scope of the invention.

1. A system for freezing/chilling materials, comprising:
an inlet for receiving the materials;
a pump for applying a positive pressure to the materials to facilitate flow of the materials through the system;
at least one module in fluid communication with the pump to receive the materials and to store the materials therein for a predetermined period of time as a stationary batch of material for freezing/chilling, the at least one module having an internal wall in communication with the stationary batch of material stored therein that is adapted to apply a low temperature to the materials to at least partially freeze the stationary batch of material and which is adapted to apply a heat to the at least partially frozen stationary batch of material to defrost the stationary batch of material at an interface between the stationary batch of material and the internal wall; and
an outlet for receiving the at least partially frozen batch of material from the at least one module;
wherein, the flow of the material is controllable to deliver the material into the at least one module and to stop further flow of the material into the at least one module to form the stationary batch of material within the at least one module, and the flow of the material is further controllable to recommence flow of the material into the at least one module following the defrost to cause the at least partially frozen batch of material to be received by the outlet from the at least one module.

2. A system according to claim 1, wherein the at least one module comprises a body forming a conduit and the internal wall defines an internal space formed within the conduit for receiving the stationary batch of material for chilling/freezing, and the body further comprises an external wall spaced from the internal wall to define at least one channel formed therebetween that extends a length of the body to receive a heat exchange medium.

3. A system according to claim 2, wherein the body is extruded from a metal and comprises a plurality of channels extending the length of the body.

4. A system according to claim 2, wherein the body comprises an internal tube that defines the internal space for receiving the stationary batch of material for chilling/freezing and an external shell formed over said internal tube to form the at least one channel therebetween.

5. A system according to claim 2, wherein an inlet manifold is attached to an inlet end of the at least one module, the inlet manifold having at least one inlet for introducing the heat exchange medium into the at least one channel and being controllable to introduce the material to be frozen/chilled into the internal space of the body.

6. A system according to claim 5, wherein the inlet manifold includes one or more valve members to control the introduction of the material to be chilled/frozen into the internal space thereof to form the stationary batch of material for freezing/chilling.

7. A system according to claim 2, wherein an outlet manifold is attached to the outlet, the outlet manifold having at least one outlet for removing a heat exchange medium from the at least one channel and being controllable to receive the at least partially frozen batch of material from the at least one module.

8. A system according to claim 7, wherein the outlet manifold includes cutters, guillotines, and/or robotic handling systems to receive and process the at least partially frozen batch of material into predetermined sizes.

9. A system according to claim 8, wherein the system comprises multiple modules arranged in parallel and the modules are controlled to operate at different cycles.

10. A method for freezing/chilling materials, comprising:
collecting the materials to be frozen/chilled;
delivering the materials to a module whereby the materials are caused to flow into the module to substantially fill the module to form a stationary batch of material for freezing/chilling;
introducing a refrigerant heat exchange medium into the module to cause the stationary batch of material present therein to form an least partially frozen batch of material;
after a predetermined time, introducing a defrost heat exchange medium into the module to replace the refrigerant heat exchange medium to cause the at least partially frozen batch of material at the interface of the module to at least partially melt;
applying a positive pressure to the module to cause the at least partially frozen batch of material present in the module to be expelled out of the module; and
collecting the at least partially frozen batch of material expelled from the module for further processing.

11. A method according to claim 10, wherein the at least partially frozen batch of material is collected in a collection hopper for processing.

12. A method according to claim 10, wherein the materials are delivered to the module under pressure so as to flow into the module to substantially fill the module.

13. A method according to claim 12, wherein the materials are delivered to the module under pressure supplied by a pump.

14. A method according to claim 12, wherein the module comprises an elongated space into which the materials are delivered to form the stationary batch of material for freezing/chilling and the materials flow into the elongated space such that the stationary batch of material for freezing/chilling substantially fills the elongated space.

15. A method according to claim 14, wherein the module comprises one or more channels configured to extend along the elongated space such that the refrigerant heat exchange medium is introduced into the one or more channels to cause the stationary batch of material present in the elongate channel to at least partially freeze.

16. A method according to claim 15, wherein after the predetermined time period, the refrigerant heat exchange medium in the one or more channels is replaced with the defrost heat exchange medium such that the stationary batch of material present at the interface of the elongate space is caused to at least partially melt.

17. A method according to claim 10, wherein the positive pressure is applied to the module in the form of pressurised air.

18. A method according to claim 10, wherein the positive pressure is applied to the module by fresh material delivered into the module under pressure to cause the at least partially frozen batch of material present in the module to flow out of the module.

19. A method according to claim 18, wherein the pressure is supplied to the fresh material by a pump.

20. A method according to claim 10, wherein the at least partially frozen batch of material ejected from the module exits the module by way of an exit manifold.

21. A method according to claim 20, wherein the exit manifold comprises cutters, guillotines, and robotic handling systems to receive and process the at least partially frozen batch of material into predetermined sized slabs.
